(19) United States
(12) Patent Application Publication
(10) Pub. No.: US 2020/0265972 A1
(43) Pub. Date: Aug. 20, 2020

(54) MULTI-CONDUCTOR FLAT CABLE FOR DOWNHOLE OPERATIONS

(71) Applicant: Halliburton Energy Services, Inc., Houston, TX (US)

(72) Inventors: Terry Lynn Glasscock, Vinita, OK (US); Thomas John Gottschalk, Houston, TX (US); Yaimir Erika Elejalde, Broken Arrow, OK (US)

(21) Appl. No.: 16/348,796

(22) PCT Filed: Dec. 20, 2018
(86) PCT No.: PCT/US2018/066839

§ 371 Date: May 9, 2019

Related U.S. Application Data
(60) Provisional application No. 62/703,235, filed on Jul. 25, 2018.

(51) Int. Cl. H01B 7/08; H01B 7/04; H01B 7/18

(52) U.S. Cl. CPC H01B 7/0823; H01B 7/1895; H01B 7/046; H01B 7/0869

(57) ABSTRACT

An apparatus includes a flat cable that comprises multiple conductors that are encased in the cable armor and positioned in a flat cable configuration such that a void area is defined between the multiple conductors. The flat cable includes a filler positioned at least partially in the void area.

### BACKGROUND

The disclosure generally relates to the field of downhole operations, and more particularly to a multi-conductor flat cable for downhole operations.

The ambient environment downhole can result in detrimental effects on the cables and equipment operating downhole. For example, the detrimental effects can include high temperature, thermal expansion, gas swelling, etc.

### BRIEF DESCRIPTION OF THE DRAWINGS

Aspects of the disclosure may be better understood by referencing the accompanying drawings.

FIG. 1 depicts an example electric submersible pump assembly having low profile cabling, according to some embodiments.

FIG. 2 depicts a cross-sectional view of a flat cable having multiple conductors in a flat cable configuration without filler and prior to being deformed due to the ambient environment downhole.

FIG. 3 depicts a cross-sectional view of the flat cable of FIG. 2 after exposure to detrimental effects downhole.

FIG. 4 depicts a cross-sectional view of a first example of a flat cable with filler, according to some embodiments.

FIG. 5 depicts an alternative view of the example of FIG. 4, according to some embodiments.

FIG. 6 depicts a cross-sectional view of a flat cable with I-beam shaped fillers, according to some embodiments.

FIG. 7 depicts an alternative view of the example of FIG. 6, according to some embodiments.

FIG. 8 depicts a cross-sectional view of a flat cable having fillers with different shapes, according to some embodiments.

FIG. 9 depicts example operations of manufacturing a flat cable, according to some embodiments.

### DESCRIPTION

The description that follows includes example systems, methods, techniques, and program flows that embody aspects of the disclosure. However, it is understood that this disclosure may be practiced without these specific details. For instance, this disclosure includes example fillers for cabling. Aspects of this disclosure can include other example fillers to provide radial containment for the cables and to keep the insulation and metallic jacket material from displacing to fill the void area. Additionally, while described in reference to downhole operations, aspects of the disclosure can be used in other types of similar environments that include high temperature, thermal expansion, gas swelling, etc.

Some embodiments include a cable in a flat configuration with multiple (e.g., three) conductors. The flat configuration provides for a lower profile, thereby reducing the likelihood of being damaged during operation. Each conductor can be surrounded by an insulation (e.g., ethylene propylene diene monomer (EPDM) rubber), which is surrounded by a metallic (e.g., lead) jacket. The metallic jacket provides containment of the insulation and generally seals off the insulation and conductors from downhole fluids and gases. However, when the ambient temperature exceeds a level, the insulation and possibly the metallic jacket can swell, thereby causing the deformation of the metallic jacket.

In some embodiments, a filler is positioned between the metallic jackets surrounding the multiple conductors and the external cable armor. Such embodiments provide radial containment to the conductors to keep the insulation and jacket materials from displacing to fill the void area. Such embodiments also reduce deformation of the metallic jackets. In particular, such embodiments reduce or preclude creation of a deformed metallic jacket having sharp edges. These sharp edges can damage the cable, thereby making the cable inoperable.

In some embodiments, the conductors are individually contained by special stainless steel struts. In this case, the filler can be positioned between the insulated and jacketed phases. Various embodiments can result in improved reliability, improved run time, improved re-usability of the cable and higher temperature application robustness. Additionally, various embodiments can reduce risk of short runs and reduce risk of warranty payout.

A filler can be placed in the void areas between the individual cables to support each leg of the cable and stop deformation observed when the cabling is exposed to high temperatures. The filler can be any number of materials. In some embodiments, the filler material can have any of a number of high temperature ratings (e.g., 450 degrees Fahrenheit (° F.), 475° F., 500° F., etc.). For example, the filler temperature rating can match the rating for the cabling. Additionally, the fillers can be in different shapes and configurations.

### Example System

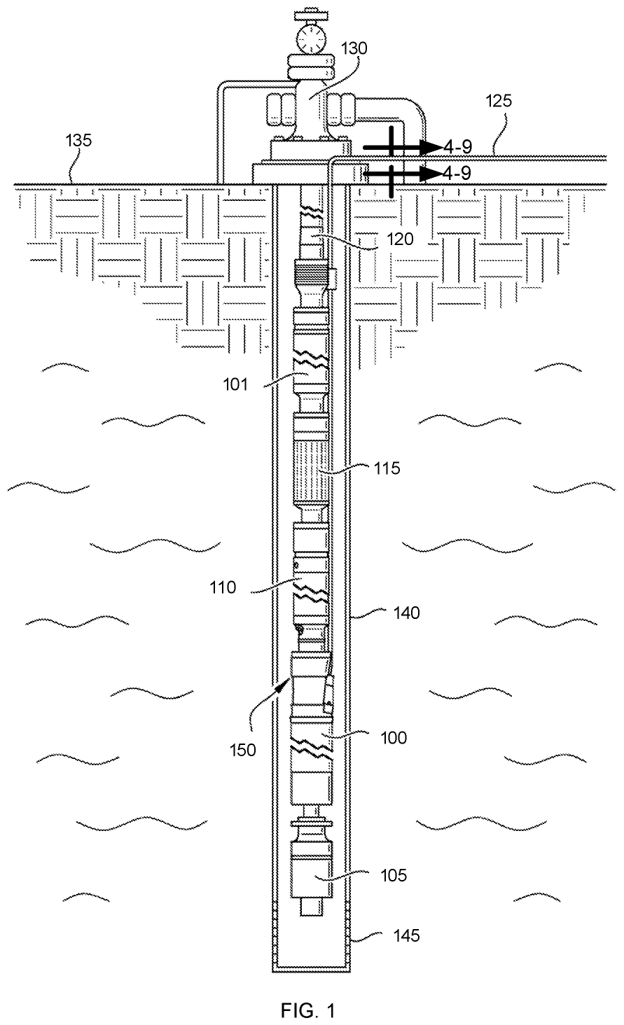

The cables described herein can be used in a number of different systems and environments. An example system in a downhole application is now described. In particular, FIG. 1 depicts an example electric submersible pump assembly having low profile cabling, according to some embodiments. A multistage centrifugal pump 101 may be situated in a downhole well, such as an oil or natural gas well. Fluid may enter a casing 140 through perforations 145 in casing. A downhole well and/or ESP assembly 150 may be vertical, horizontal or operate within a bend or radius. An electric submersible motor 100 may operate to turn a shaft of the centrifugal pump 101 and may be a two-pole, three phase squirrel cage induction motor. A power cable 125 may provide power to a motor 100 from a power source located at surface 135 of the well. The power cable 125 can be a flat cable according to example embodiments described below. For example, the power cable 125 can include multiple conductors in a cable armor, wherein each wrapped in insulation and then wrapped in a metallic jacket. A filler can be positioned in the cable armor between the conductors (as further described below).

In gaseous wells, a gas separator and/or a tandem charge pump may be included in the ESP assembly 150. A gas separator and/or intake section 115 may serve as the intake for fluid into the centrifugal pump 101. A seal section 110 may equalize pressure in the motor 100 and keep well fluid from entering motor 100. A production tubing 120 may carry lifted fluid to a wellhead 130 and/or the surface 135 of the well. Downhole sensors 105 may be mounted internally or externally to the ESP assembly 150, below, above, and/or proximate the motor 100.

### Example Cables

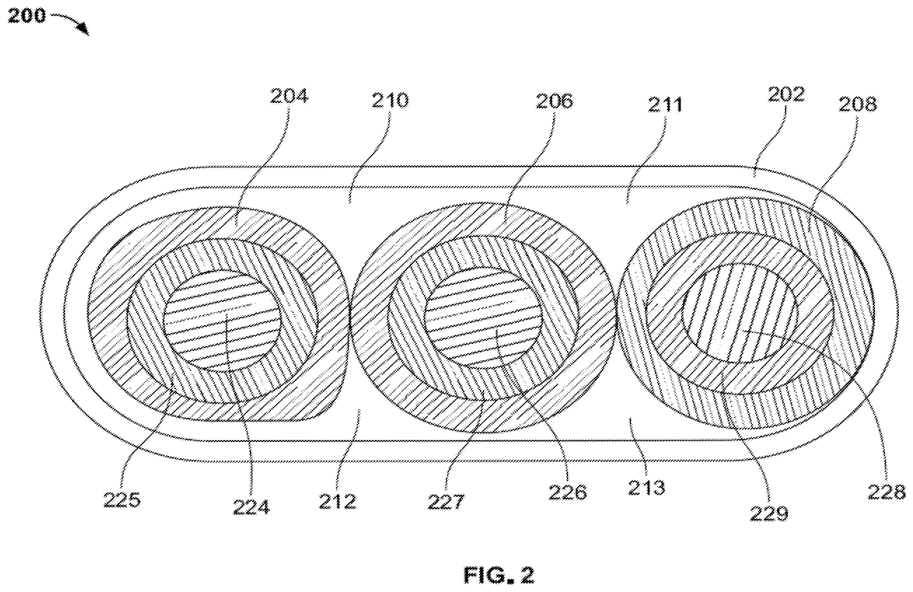

FIG. 2 depicts a cross-sectional view of a flat cable having multiple conductors in a flat cable configuration without filler and prior to being deformed due to the ambient environment downhole. In FIG. 2, a flat cable 200 includes a conductor 224, a conductor 226, and a conductor 228 that are positioned in an example flat cable configuration. In this flat cable configuration, the conductors 224-228 are laterally positioned adjacent to each other to reduce the overall profile of the flat cable. The conductor 224 is wrapped in insulation 225 which is wrapped by a metallic jacket 204. The conductor 226 is wrapped in insulation 227 which is wrapped by a metallic jacket 206. The conductor 228 is wrapped in insulation 229 which is wrapped by a metallic jacket 208. The flat cable 200 also includes a cable armor 202 encasing the conductors—wrapped around the metallic jackets 204-208. In FIG. 2, there is no filler between the metallic jackets 204-208 within the cable armor 202. Rather, there are voids 210-213 between the metallic jackets 204-208 within the cable armor 202.

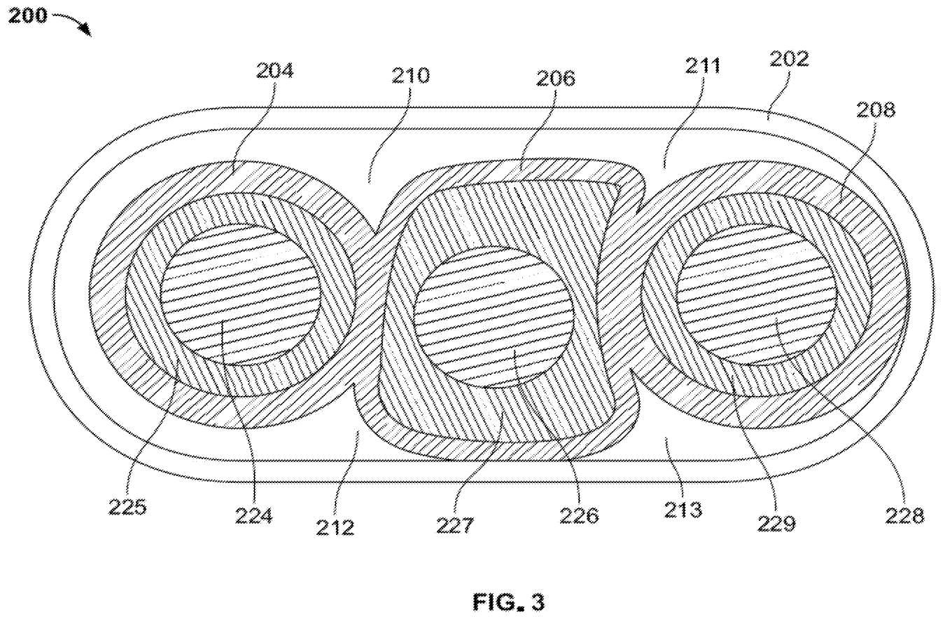

FIG. 3 depicts a cross-sectional view of the flat cable of FIG. 2 after exposure to detrimental effects downhole. The detrimental effects can include high temperature, high pressure, etc. As shown, the insulation 227 has expanded as a result of the detrimental effects causing the metallic jackets 204-208 to deform. Because of the expansion, the voids 210-213 are reduced and/or essentially eliminated.

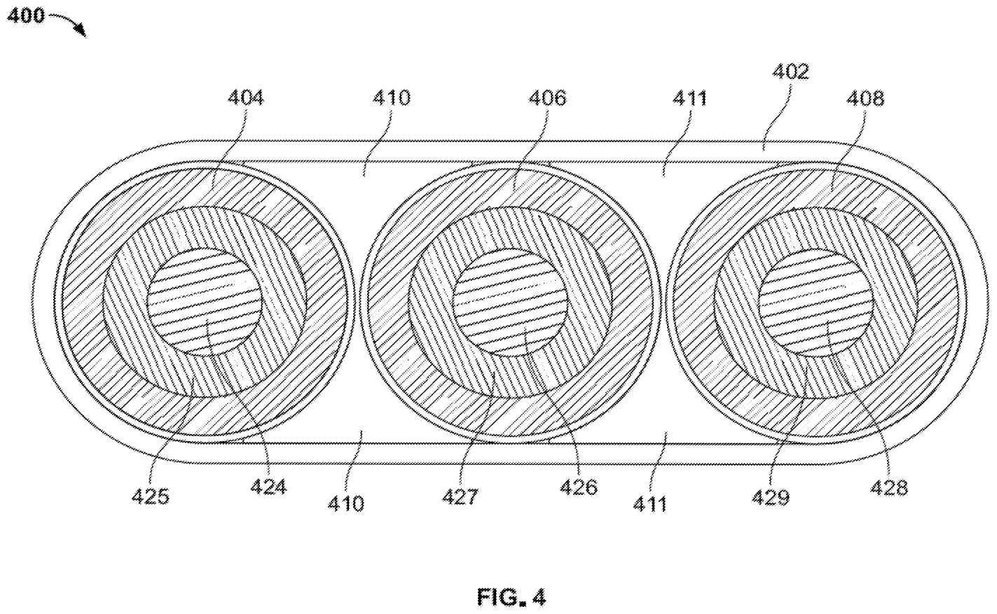

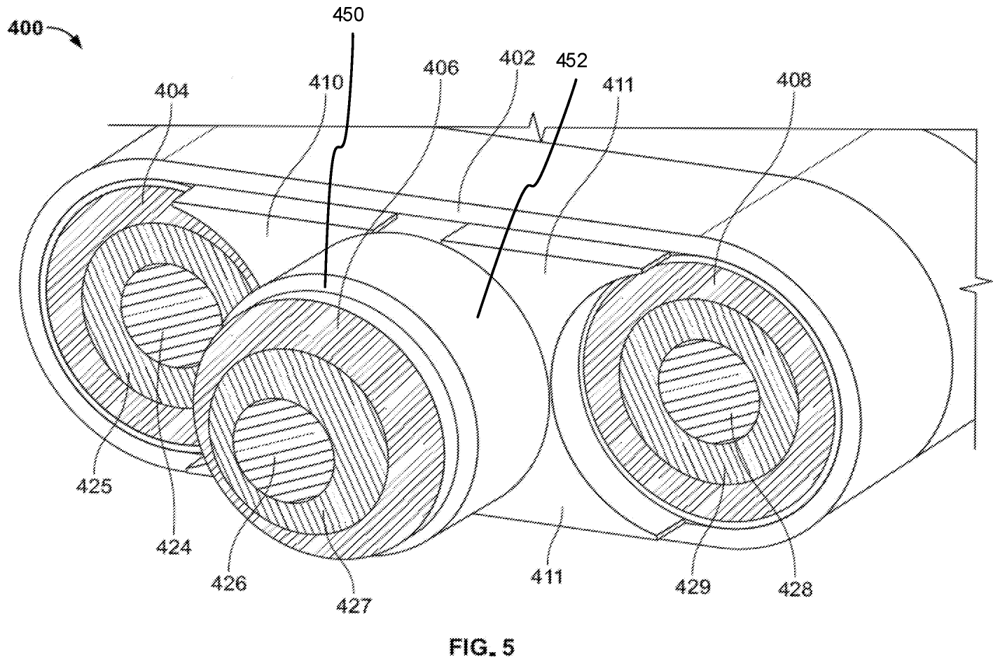

Example cables according to various embodiments are now described. FIG. 4 depicts a cross-sectional view of a first example of a flat cable with filler, according to some embodiments. FIG. 5 depicts an isometric view of the example of FIG. 4, according to some embodiments.

In particular, FIGS. 4-5 depict a flat cable 400 that includes a conductor 424, a conductor 426, and a conductor 428 that are positioned in an example flat cable configuration. In this flat cable configuration, the conductors 424-428 are laterally positioned adjacent to each other to reduce the overall profile of the flat cable. The conductor 424 is wrapped in insulation 425 which is wrapped by a metallic jacket 404. The conductor 426 is wrapped in insulation 427 which is wrapped by a metallic jacket 406. The conductor 428 is wrapped in insulation 429 which is wrapped by a metallic jacket 408.

As shown in FIG. 5 a barrier tape 450 can be wrapped around the metallic jacket 406 to further protect the conductors from external elements, such as downhole gases and fluids. Additionally, bedding tape 452 can be wrapped around the barrier tape 450 is a sacrificial material (e.g., mylar) used to protect the metallic jacket during the armoring process to wrap the cable armor 402 around the filler and the conductors. While only depicted for the middle conductor 426, the barrier tape 450 and/or the bedding tape 452 can be similarly wrapped around the other conductors.

A filler 410 is positioned above and between the metallic jacket 404 and the metallic jacket 406. A filler 411 is positioned above and between the metallic jacket 406 and the metallic jacket 408. The fillers 410-411 can be any type of material that prevents or reduces expansion of the insulation. For example, the fillers can be composed of silicon, PEEK, etc. A cable armor 402 is then wrapped around the jackets 404-408 and the fillers 410-411.

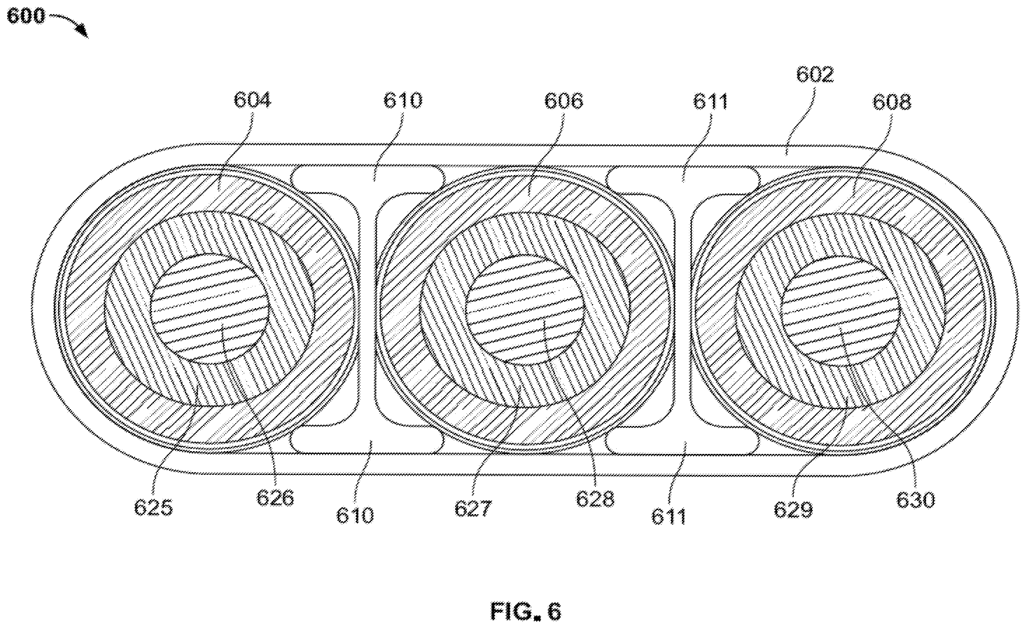

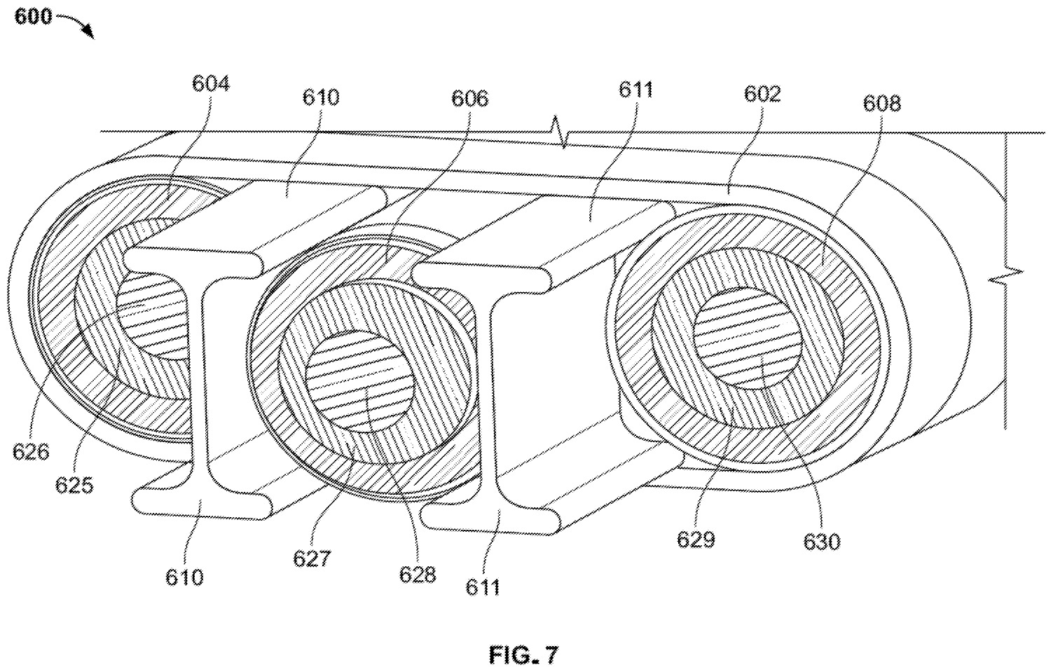

FIG. 6 depicts a cross-sectional view of a flat cable with I-beam shaped fillers, according to some embodiments. FIG. 7 depicts an isometric view of the example of FIG. 6, according to some embodiments. In particular, FIGS. 6-7 depict a flat cable 600 that includes a conductor 624, a conductor 626, and a conductor 628 that are positioned in an example flat cable configuration. In this flat cable configuration, the conductors 624-628 are laterally positioned adjacent to each other to reduce the overall profile of the flat cable. The conductor 624 is wrapped in insulation 625 which is wrapped by a metallic jacket 604. The conductor 626 is wrapped in insulation 627 which is wrapped by a metallic jacket 606. The conductor 628 is wrapped in insulation 629 which is wrapped by a metallic jacket 608. A filler 610 and a filler 611 both have an I-beam shape. The filler 610 is positioned between the metallic jacket 604 and the metallic jacket 606. The filler 611 is positioned between the metallic jacket 606 and the metallic jacket 608. The fillers 610-611 can be any type of material that prevents or reduces expansion of the insulation. For example, the fillers can be composed of silicon, PEEK, etc. A cable armor 602 is then positioned around the metallic jackets 604-608 and the fillers 610-611.

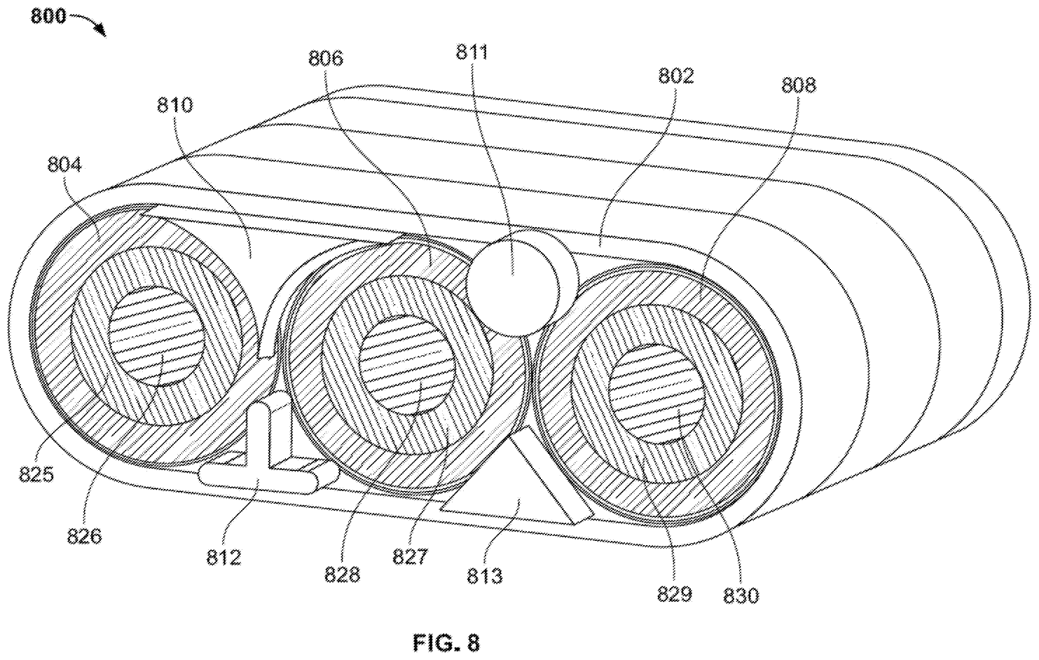

FIG. 8 depicts a cross-sectional view of a flat cable having fillers with different shapes, according to some embodiments. FIG. 8 depicts a flat cable 800 that includes a conductor 824, a conductor 826, and a conductor 828 that are positioned in an example flat cable configuration. In this flat cable configuration, the conductors 824-828 are laterally positioned adjacent to each other to reduce the overall profile of the flat cable. The conductor 824 is wrapped in insulation 825 which is wrapped by a metallic jacket 804. The conductor 826 is wrapped in insulation 827 which is wrapped by a metallic jacket 806. The conductor 828 is wrapped in insulation 829 which is wrapped by a metallic jacket 808. The cables 824-828 are positioned such that void areas are defined between and around the cables 824-828. In this example, each of the fillers have a different shape. A filler 810 has a triangular shape. A filler 812 has a circular shape. A filler 814 has a T shape. A filler 818 has a different triangular shape. The fillers 810-818 are added to at least partially fill the void areas and to prevent the deformation of the cables 704-708 after exposure to the ambient environment downhole.

### Example Operations

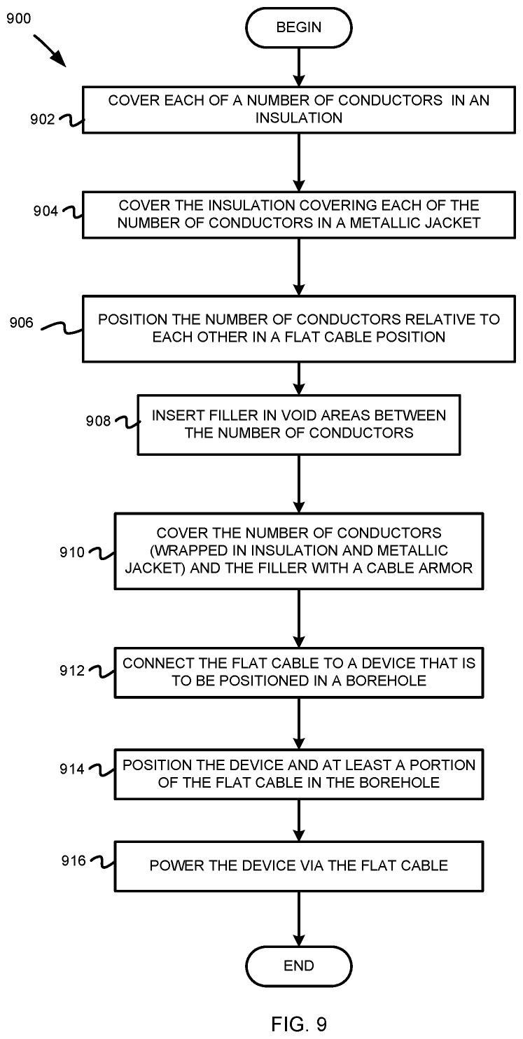

Example operations for manufacturing a flat cable are now described. In particular, FIG. 9 depicts example operations of manufacturing a flat cable, according to some embodiments. A flowchart 900 of FIG. 9 is described with reference to the example flat cable depicted in FIGS. 4-5 and the example electric submersible pump assembly depicted in FIG. 1.

At block 902, each of a number of conductors is covered in an insulation. For example, with reference to FIGS. 4-5, the conductors 424-428 are covered in the insulation 425-429, respectively.

At block 904, the insulation covering each of the number of conductors is covered in a metallic jacket. For example, with reference to FIGS. 4-5, the insulation 425-429 is covered in metallic jackets 404-408, respectively.

At block 906, the number of conductors are positioned relative to each other in a flat cable position. For example, with reference to FIGS. 4-5, after being wrapped or covered in insulation and a metallic jacket, the conductors 424-428 are positioned laterally adjacent to each other to create a low profile. In this example of a flat cable position, the conductor 424 is positioned adjacent to the conductor 426. The conductor is positioned adjacent to the conductor 428.

At block 908, filler is inserted in void areas between the number of conductors. For example, with reference to FIGS. 4-5, the filler 410 is inserted in the void areas between and around the conductor 424 and the conductor 426. The filler 411 is inserted in the void areas between and around the conductor 426 and the conductor 428. In this example the filler has a triangle shape on the top and bottom between the conductors. As described above, a shape of the filler can be circular, hour glass, a triangle, a T shape, an I-beam, etc. In some embodiments, the same flat cable can include filler of different shapes. In some embodiments, a mechanism of internal support such as a string or small wire can aid in pulling the filler material out of an extruder. This support mechanism can be either permanent or sacrificial. A purpose of this support mechanism is to aid in manufacturing of the filler itself. While the fillers are described as solid components that are assembled into the cable during manufacturing, in some embodiments, the fillers can be fluids during a fluid injection process to fill the void areas during manufacturing.

At block 910, the number of conductors (wrapped in insulation and metallic jacket) and the filler are covered with a cable armor. For example, with reference to FIGS. 4-5, the cable armor cable armor 402 is then wrapped around to cover the jackets 404-408 and the fillers 410-411.

The previous operations include example operations to assembly the flat cable. The subsequent operations of the flowchart 900 includes example operations of use of the flat cable.

At block 912, the flat cable is connected to a device that is to be positioned in a borehole. For example, with reference to FIG. 1, the flat cable includes the power cable 125 and the device includes the motor 100. The power cable 125 is connected to the motor 100.

At block 914, the device and at least a portion of the flat cable are positioned in the borehole. For example, with reference to FIG. 1, the motor 100 is lowered into the borehole with the power cable 125 at least partially being positioned in the borehole.

At block 916, the device is powered via the flat cable. For example, with reference to FIG. 1, the motor 100 is powered from a power source at the surface via the power cable 125 to turn a shaft of the centrifugal pump 101 as part of the downhole operations of the electric submersible pump assembly.

While the aspects of the disclosure are described with reference to various implementations and exploitations, it will be understood that these aspects are illustrative and that the scope of the claims is not limited to them. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### EXAMPLE EMBODIMENTS

Example embodiments include the following:

### Embodiment 1

An apparatus comprising: a flat cable comprising, multiple conductors that are encased in the cable armor and positioned in a flat cable configuration such that a void area is defined between the multiple conductors; and a filler positioned at least partially in the void area.

### Embodiment 2

The apparatus of Embodiment 1, wherein a shape of the filler is circular.

### Embodiment 3

The apparatus of Embodiments 1 or 2, wherein a shape of the filler is hour glass.

### Embodiment 4

The apparatus of any one of Embodiments 1-3, further comprising an insulation wrapped around each of the multiple cables.

### Embodiment 5

The apparatus of Embodiment 4, further comprising a jacket wrapped around the insulation that is wrapped around each of the multiple cables.

### Embodiment 6

The apparatus of Embodiment 5, wherein the jacket is composed of lead.

### Embodiment 7

The apparatus of Embodiment 5, wherein the void area is defined between the cable armor and each of the jackets.

### Embodiment 8

The apparatus of any one of Embodiments 1-7, wherein a shape of the filler comprises an I-beam.

### Embodiment 9

The apparatus of any one of Embodiments 1-8, wherein a shape of the filler comprises at least one of a triangle, and a T shape.

### Embodiment 10

A system comprising: a centrifugal pump; a motor coupled to turn a shaft of the centrifugal pump to pump fluid downhole; and a power cable electrically coupled to supply power to the motor, wherein the power cable comprises, multiple conductors that are encased in the cable armor and positioned in a flat cable configuration such that a void area is defined between the multiple conductors; and a filler positioned at least partially in the void area.

### Embodiment 11

The system of Embodiment 10, wherein a shape of the filler is circular.

### Embodiment 12

The system of Embodiments 10 or 11, wherein a shape of the filler is hour glass.

### Embodiment 13

The system of any one of Embodiments 10-12, further comprising an insulation wrapped around each of the multiple cables.

### Embodiment 14

The system of Embodiment 13, further comprising a jacket wrapped around the insulation that is wrapped around each of the multiple cables.

### Embodiment 15

The system of Embodiment 14, wherein the jacket is composed of lead.

### Embodiment 16

The system of Embodiment 14, wherein the void area is defined between the cable armor and each of the jackets.

### Embodiment 17

The system of any one of Embodiments 10-16, wherein a shape of the filler comprises an I-beam.

### Embodiment 18

The system of any one of Embodiments 10-17, wherein a shape of the filler comprises at least one of a triangle, and a T shape.

### Embodiment 19

A method comprising: covering each of a number of conductors in an insulation; covering the insulation covering each of a number of conductors in a metallic jacket; positioning the number of conductors relative to each other in a flat cable position; inserting filler into void areas among the number of conductors; and covering the number of conductors and the filler with a cable armor to form a flat cable.

### Embodiment 20

The method of Embodiment 19, further comprising: connecting the flat cable to a device to be positioned in a borehole; positioning the device and at least a portion of the flat cable in the borehole; powering the device via the flat cable, wherein a shape of the filler comprises at least one of circular, hour glass, a triangle, a T shape, and an I-beam.

What is claimed is:

1. An apparatus comprising:
a flat cable comprising,
multiple conductors that are encased in the cable armor and positioned in a flat cable configuration such that a void area is defined between the multiple conductors; and
a filler positioned at least partially in the void area.

2. The apparatus of claim 1, wherein a shape of the filler is circular.

3. The apparatus of claim 1, wherein a shape of the filler is hour glass.

4. The apparatus of claim 1, further comprising an insulation wrapped around each of the multiple cables.

5. The apparatus of claim 4, further comprising a jacket wrapped around the insulation that is wrapped around each of the multiple cables.

6. The apparatus of claim 5, wherein the jacket is composed of lead.

7. The apparatus of claim 5, wherein the void area is defined between the cable armor and each of the jackets.

8. The apparatus of claim 1, wherein a shape of the filler comprises an I-beam.

9. The apparatus of claim 1, wherein a shape of the filler comprises at least one of a triangle, and a T shape.

10. A system comprising:
a centrifugal pump;
a motor coupled to turn a shaft of the centrifugal pump to pump fluid downhole; and
a power cable electrically coupled to supply power to the motor, wherein the power cable comprises,
multiple conductors that are encased in the cable armor and positioned in a flat cable configuration such that a void area is defined between the multiple conductors; and
a filler positioned at least partially in the void area.

11. The system of claim 10, wherein a shape of the filler is circular.

12. The system of claim 10, wherein a shape of the filler is hour glass.

13. The system of claim 10, further comprising an insulation wrapped around each of the multiple cables.

14. The system of claim 13, further comprising a jacket wrapped around the insulation that is wrapped around each of the multiple cables.

15. The system of claim 14, wherein the jacket is composed of lead.

16. The system of claim 14, wherein the void area is defined between the cable armor and each of the jackets.

17. The system of claim 10, wherein a shape of the filler comprises an I-beam.

18. The system of claim 10, wherein a shape of the filler comprises at least one of a triangle, and a T shape.

19. A method comprising:
covering each of a number of conductors in an insulation;
covering the insulation covering each of a number of conductors in a metallic jacket;
positioning the number of conductors relative to each other in a flat cable position;
inserting filler into void areas among the number of conductors; and
covering the number of conductors and the filler with a cable armor to form a flat cable.

20. The method of claim 19, further comprising:
connecting the flat cable to a device to be positioned in a borehole;
positioning the device and at least a portion of the flat cable in the borehole;
powering the device via the flat cable, wherein a shape of the filler comprises at least one of circular, hour glass, a triangle, a T shape, and an I-beam.
